(19) United States
(12) Patent Application Publication
(10) Pub. No.: US 2014/0214515 A1
(43) Pub. Date: Jul. 31, 2014

(54) PROMOTIONAL CODE REDEMPTION FOR IN-APPLICATION FEATURES USED WITH APPLICATION PROGRAMS

(71) Applicant: APPLE INC., Cupertino, CA (US)

(72) Inventors: Gregory T. Quirk, Maple Glen, PA (US); Michael Kuohao Chu, Cupertino, CA (US); Steven Quirk, Millburn, NJ (US); Wayne Yap, San Francisco, CA (US); Pedraum Pardehpoosh, Palo Alto, CA (US)

(73) Assignee: Apple Inc., Cupertino, CA (US)

(21) Appl. No.: 13/756,246

(22) Filed: Jan. 31, 2013

(51) Int. Cl. G06Q 30/02

(52) U.S. Cl. CPC G06Q 30/0225
USPC 705/14.26

(57) ABSTRACT

Improved techniques and systems for redemption of a promotional code for acquisition of a digital product, such as an in-application asset, for use in a corresponding application program are disclosed. The in-application asset can, for example, pertain to a consumable asset or a non-consumable asset. The techniques and systems can operate to validate the promotional code that is being redeemed to acquire the in-application asset, and can confirm that a requestor's redemption device has the corresponding application program installed thereon. Compatibility of the corresponding application program with the in-application asset can be confirmed. Updates to the corresponding application program can also be provided.

### BACKGROUND OF THE INVENTION

Conventionally, promotional codes can be distributed for songs, application programs, etc. Recipients of the promotional codes can use the promotional codes to obtain an associated song, application program, etc. For example, a user can access an online store, such as the iTunes Music Store from Apple Inc., and redeem a promotional code for a song using the online store. If the promotional code being redeemed is valid, the user gains access to the associated song, typically without cost.

Similarly, an application program developer can be provided with one or more promotional codes that can be used to obtain an associated application program. For example, iTunes Connect allows a developer to obtain promotional codes that the developer can distribute to product reviewers, friends, etc. The recipients can then redeem the promotional codes via an online store, such as the iTunes App Store from Apple Inc., and thereby receive the application program, typically without cost.

Unfortunately, however, there remains a need for enhanced distribution and usage of promotional codes for other types of digital products.

### SUMMARY

Improved techniques and systems for redemption of a promotional code for acquisition of a digital product, such as an in-application asset, for use in a corresponding application program are disclosed. The in-application asset can, for example, pertain to a consumable asset or a non-consumable asset. The techniques and systems can operate to validate the promotional code that is being redeemed to acquire the in-application asset, and can confirm that a requestor's redemption device has the corresponding application program installed thereon. Compatibility of the corresponding application program with the in-application asset can be confirmed. Updates to the corresponding application program can also be provided.

In one embodiment, through use of a mobile computing device, a code can be redeemed via the mobile computing device to acquire an in-application asset that can be used with a corresponding application program previously installed on the mobile computing device. Such a code, which can be referred to as a promotional code, provides a convenient and substantially automated way to offer application program owners in-application assets that can be used by application programs.

The invention can be implemented in numerous ways, including as a method, system, device, apparatus (including computer readable medium and graphical user interface). Several embodiments of the invention are discussed below.

As a method for redeeming a promotional code to acquire an in-application asset, one embodiment can, for example, include at least: receiving, at one or more computing devices, a redemption code request including a submitted in-application promotional code for an in-application asset, the redemption code request being submitted by a requesting device; determining, at the one or more computing devices, whether the submitted in-application promotional code is valid; determining, at the one or more computing devices, an application program associated with the submitted in-application promotional code; determining, at the one or more computing devices, whether the application program is installed on the requesting device; and rendering the in-application asset available to the application program at the requesting device if (i) the submitted in-application promotional code is determined to be valid, and (ii) the application program associated with the submitted in-application promotional code is installed on the requesting device.

As a method for redeeming a promotional code to acquire an in-application feature for use in an application program, one embodiment can, for example, include at least: receiving, at one or more computing devices, a redemption code request including a submitted in-application promotional code for an in-application feature, the redemption code request being submitted by a request or using a requesting device; determining, at the one or more computing devices, whether the submitted in-application promotional code is valid; determining, at the one or more computing devices, an application program associated with the submitted in-application promotional code; determining, at the one or more computing devices, whether the requestor has previously acquired rights to use the application program; determining, at the one or more computing devices, whether the application program is installed on the requesting device; and rendering the in-application feature available to the application program at the requesting device if (i) the submitted in-application promotional code is determined to be valid, (ii) the requestor has previously acquired rights to use the application program, and (iii) the application program associated with the submitted in-application promotional code is installed on the requesting device.

As a computer readable medium including at least computer program code tangible stored therein for redeeming a promotional code to acquire an in-application asset, one embodiment can, for example, include at least: computer readable medium for receiving a redemption code request including a submitted in-application promotional code for an in-application asset, the redemption code request being submitted by a requesting device; computer readable medium for determining whether the submitted in-application promotional code is valid; computer readable medium for determining an application program associated with the submitted in-application promotional code; computer readable medium for determining whether the application program is installed on the requesting device; and computer readable medium for rendering the in-application asset available to the application program at the requesting device if (i) the submitted in-application promotional code is determined to be valid, and (ii) the application program associated with the submitted in-application promotional code is installed on the requesting device.

As a computer readable medium including at least computer program code tangible stored therein for redeeming a promotional code to acquire an in-application feature, the computer readable medium comprising: computer readable medium for receiving a redemption code request including a submitted in-application promotional code for an in-application feature, the redemption code request being submitted by a request or using a requesting device; computer readable medium for determining whether the submitted in-application promotional code is valid; computer readable medium for determining an application program associated with the submitted in-application promotional code; computer readable medium for determining whether the requestor has previously acquired rights to use the application program; computer readable medium for determining whether the application program is installed on the requesting device; and computer readable medium for rendering the in-application feature available to the application program at the requesting device if (i) the submitted in-application promotional code is determined to be valid, (ii) the requestor has previously acquired rights to use the application program, and (iii) the application program associated with the submitted in-application promotional code is installed on the requesting device.

As a system for supporting redemption of promotional codes to acquire in-application features for use with application programs, one embodiment can, for example, include at least a code redemption system, and an in-application asset acquisition manager. The code redemption system can be configured to receive a code redemption request and permit or decline the code redemption request based on one or more criteria. The code redemption request can include at least a submitted in-application promotional code. The in-application asset acquisition manager can be configured to at least: (a) determine an application program associated with the submitted in-application promotional code; (b) determine whether the application program is installed on the requesting device; and (c) render the in-application feature available to the application program at the requesting device if (i) the submitted in-application promotional code is determined by the code redemption system to be valid, (ii) the requestor has previously acquired rights to use the application program, and (iii) the application program associated with the submitted in-application promotional code is installed on the requesting device.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of an in-application redemption and acquisition system according to one embodiment.

FIG. 2A illustrates a flow diagram of an in-application code redemption process according to one embodiment.

FIG. 2B illustrates a compatibility check process according to one embodiment.

FIG. 2C illustrates a flow diagram of a program update process according to one embodiment.

FIG. 3A-3C illustrates a flow diagram of an in-application code redemption process according to another embodiment.

FIG. 3D illustrates a compatibility check process according to one embodiment.

### DETAILED DESCRIPTION OF EMBODIMENTS OF THE INVENTION

Improved techniques and systems for redemption of a promotional code for acquisition of a digital product, such as an in-application asset, for use in a corresponding application program are disclosed. The in-application asset can, for example, pertain to a consumable asset or a non-consumable asset. The techniques and systems can operate to validate the promotional code that is being redeemed to acquire the in-application asset, and can confirm that a requestor's redemption device has the corresponding application program installed thereon. Compatibility of the corresponding application program with the in-application asset can be confirmed. Updates to the corresponding application program can also be provided.

In one embodiment, through use of a mobile computing device, a code can be redeemed via the mobile computing device to acquire an in-application asset that can be used with a corresponding application program previously installed on the mobile computing device. Such a code, which can be referred to as a promotional code, provides a convenient and substantially automated way to offer application program owners in-application assets that can be used by application programs.

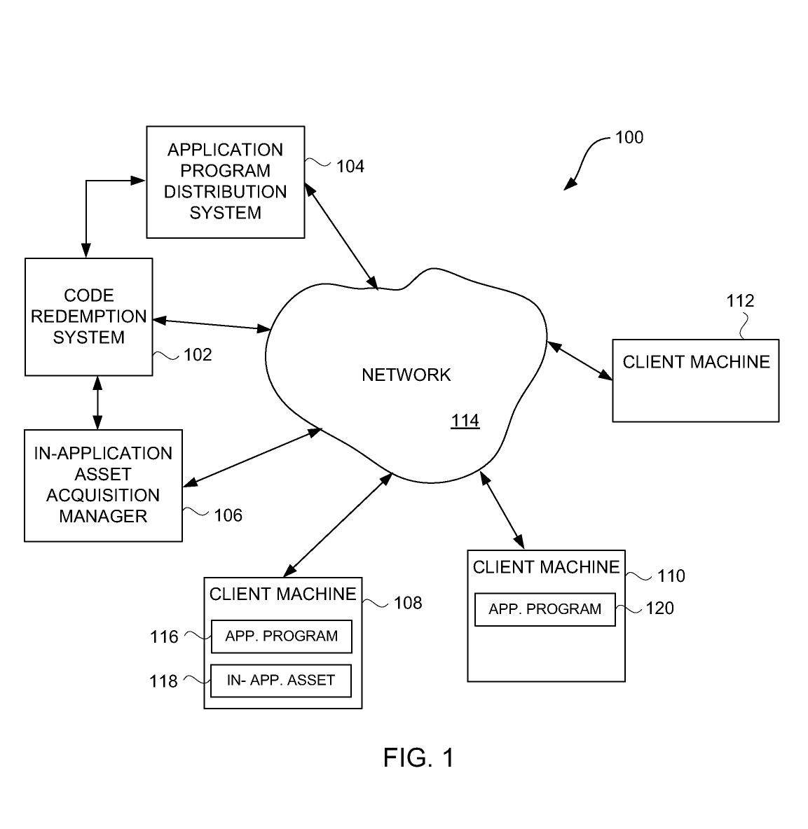

Exemplary embodiments of the invention are discussed below with reference to FIGS. 1-3D. However, those skilled in the art will readily appreciate that the detailed description given herein with respect to these figures is for explanatory purposes as the invention extends beyond these limited embodiments.

FIG. 1 is a block diagram of an in-application redemption and acquisition system 100 according to one embodiment. The in-application redemption and acquisition system 100 can include a code redemption system 102 and an application program distribution system 104. The application program distribution system 104 can be a separate system or part of a product distribution site (e.g., online store). The code redemption system 102 can also be a separate system or part of the product distribution site. To manage delivery of in-application assets, the in-application redemption and acquisition system 100 can further include an in-application asset acquisition manager 106.

Still further, the in-application redemption and acquisition system 100 can include or support one or more client machines 108-112. The client machines 108-112 can interact with any one or more of the code redemption system 102, the application program distribution system 104 and the in-application asset acquisition manager 106 via a network 114. The network 114 can include one or more wired or wireless networks. In one embodiment, the network 114 makes use of at least a portion of the Internet. In one embodiment, the connections through the network 114 between any one or more of the code redemption system 102, the application program distribution system 104 and the in-application asset acquisition manager 106 and the client machines 108-112 can be through secure connections, such as Secure Sockets Layer (SSL). The client machines 108-112 can vary with implementation but generally are computing devices that have memory storage. Often, the client machines 108-112 are personal computers or other computing devices that are capable of storing and executing application programs and/or presenting media to their users. In one embodiment, one or more of the client machines 108-112 can be portable computing devices (e.g., laptop or network computers) or handheld computing devices (e.g., PDAs, smart phones, multi-function electronic devices, or media players).

The application program distribution system 104 provides an online access point for distribution of digital products. One example of digital products is computer program products such as applications (or application programs). The application program distribution system 104 can be referred to as an online store. The application program distribution system 104 can host numerous application programs that are available for distribution (e.g., purchase). For example, application programs that have been purchased can be accessed from the application program distribution system 104 over the network 114. The application programs can include one or more supplemental features and/or can be configured to receive one or more supplemental features. The supplemental features can serve to supplement or augment corresponding application programs. As such, the supplemental features are referred to herein as in-application assets (or in-application features).

Upon acquiring (e.g., purchasing) a particular application program, the application program distribution system 104 permits digital data for the particular application program to be retrieved and then delivered (e.g., downloaded) from the application program distribution system 104 to the requesting client machines 108-112 through the network 114. In this regard, the application program distribution system 104 or some other delivery server (not shown) obtains digital data corresponding to the particular application program and downloads such digital data through the network 114 to the requesting client machines 108-112. The downloaded digital data can then be stored on the client machines 108-112. Thereafter, the client machines 108-112 can utilize (e.g., execute) the digital data of the application program.

As shown in FIG. 1, an application program 116 acquired and downloaded from the application program distribution system 104 via the network 114 can be stored on the client machine 108. Typically, the application program 116 was previously acquired from the application program distribution system 104. In one embodiment, the application program 116 can include an in-application asset 118. However, when the application program 116 is initially acquired, the in-application asset 118 can be inactive or locked such that it is not usable by the application program 116. In one embodiment, during operation of the application program 116 on the client machine 108, the application program 116 can initiate acquisition (e.g., via purchase or promotional code) of usage of the in-application asset 118. In such case, the application program 116 (itself or with assistance of an operating system) can communicate with the in-application asset acquisition manager 106. In some embodiments, acquisition of usage of the in-application asset 118 can be achieved following purchase of the application program 116 which may not include the in-application asset 118. For example, in one such embodiment, acquisition of usage of the in-application asset 118 can be achieved following submission of a promotional code for the in-application asset 118, such a submission can be initiated from the client machine 108.

The in-application asset acquisition manager 106 can manage processing of incoming requests for access to in-application assets. For example, the in-application asset acquisition manager 106 can receive an incoming request for access to in-application assets, determine whether the request is valid and permitted to be processed, process payment, if any, for such access, and send an authorization response to the requesting client machine 108. Upon receiving the authorization response, the application program 116 can render the in-application asset 118 accessible (i.e., unlocked). In such an embodiment, the in-application asset can be provided with the application program 116 as initially downloaded to the client machine 108, and thereafter only an authorization need to be delivered to the client machine 108 to render the in-application asset 118 active. However, in an alternative embodiment, the in-application asset 118 could be delivered to the client machine 108 only after determined to be valid and authorized (and thus provided separately from the delivery of the application program 116).

Although the code redemption system 102, the application program distribution system 104, and the in-application asset acquisition manager 106 are shown in FIG. 1 as being separate components, it should be understood that any of these components can be combined into one or more apparatus (e.g., one or more computing apparatus or devices, such as one or more server computers). For example, the code redemption system 104 can be incorporated into the application program distribution system 104. As another example, the in-application asset acquisition manager 106 can be incorporated into the application program distribution system 104.

The in-application redemption and acquisition system 100 can support redemption of promotional codes for in-application assets. The code redemption system 102 or the in-application asset acquisition manager 106 can operate to receive a code redemption request for an in-application asset. The code redemption request is a request from one of the client machines 108-112 for an in-application asset. The code redemption request includes a promotional code that was previously associated with the in-application asset. The promotional code from the code redemption request can then be validated at the code redemption system 102. For example, the code redemption system 102 can ensure that the particular promotional code being submitted with the code redemption request was not previously redeemed. Assuming that the promotional code is valid, the in-application asset acquisition manager 106 can determine a particular application program for the in-application asset associated with the promotional code. Then, the in application asset acquisition manager 106 can determine whether the particular application program is already installed on the particular client machine. If so, the in-application asset can be rendered usable by the particular application program at the particular client machine.

In one implementation, when the in-application asset is already provided with (e.g., included or stored with) the particular application program at the particular client machine, an authorization can then be sent to the particular client machine that permits usage of the in-application asset. For example, the client machine 108 shown in FIG. 1 stores application program 116 along with an in-application asset 118. Hence, following successful processing of a code redemption request, an authorization can be provided to the client machine 108 to enable the in-application asset 118 to be used by the application program 116.

In another implementation, when the in-application asset is not already provided with the particular application program at the particular client machine, the in-application asset (together with any needed authorization) can be sent to the particular client machine so that the in-application asset can then be used by the particular application program. For example, the client machine 110 shown in FIG. 1 stores application program 120 but does not already store an in-application asset. Hence, following successful processing of a code redemption request, the in-application asset itself (together with any required authorization) can be provided to the client machine 110 to enable the in-application asset to thereafter be used by the application program 120.

Additionally, in processing a code redemption request, it can be determined that the particular client machine does not have the particular application program installed thereon. The in-application asset requires the presence of the particular application program. Accordingly, the processing can require the presence of the particular application program. In one embodiment, the code redemption system 102 or the in-application asset acquisition manager 106 can use the application program distribution system 104 to provide the particular application program to the particular client machine. For example, the application program distribution system 104 can operate to facilitate download of the particular application program to the particular client machine. A user of the particular client machine may be required to purchase the particular application program. For example, the client machine 112 shown in FIG. 1 does not previously store the particular application program or the particular in-application asset. Hence, following successful processing of a code redemption request, the application program itself and the in-application asset (together with any required authorization) can be provided to the client machine 112 to enable the application program to be installed and to enable the in-application asset to be used by the application program.

For additional details on acquisition of application programs or supplemental features (e.g., in-application features) therefore, see U.S. patent application Ser. Nos. 13/632,033 and 12/767,756, which are incorporated herein by reference.

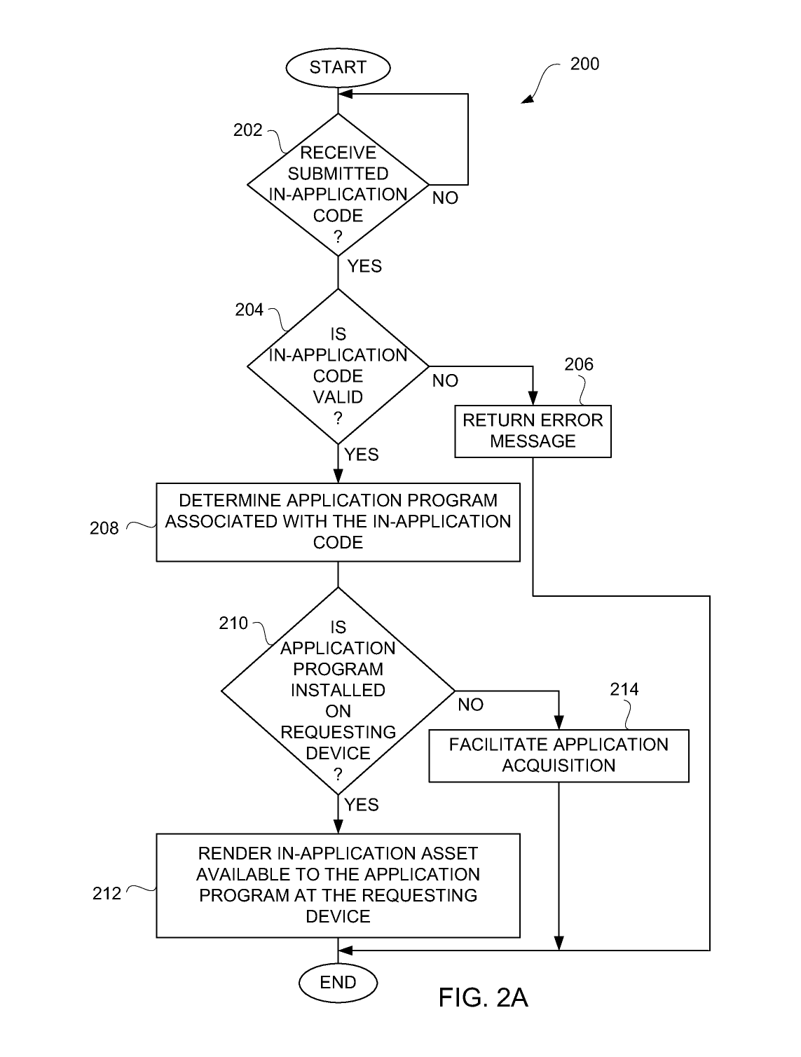

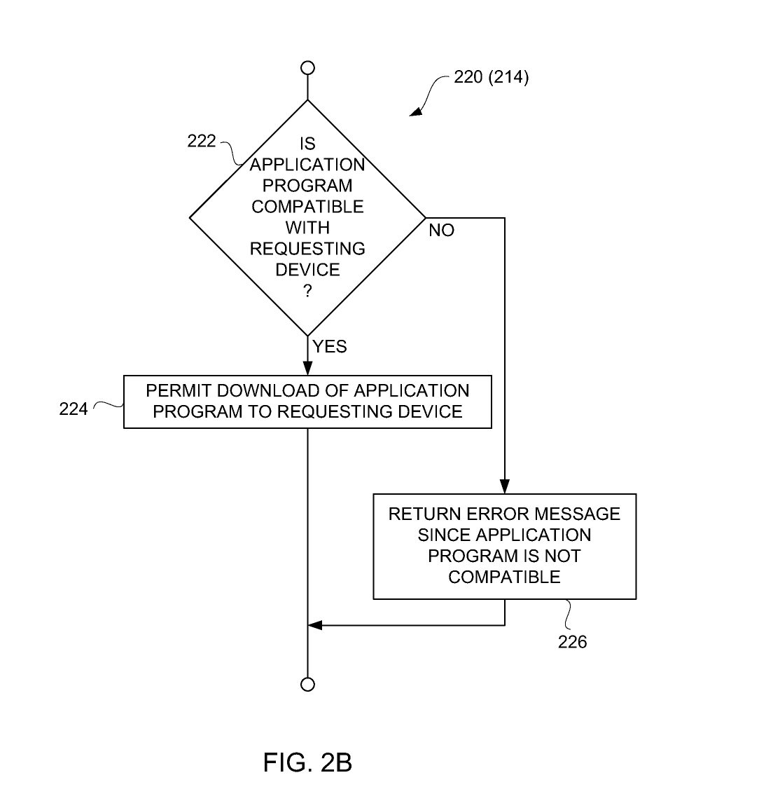

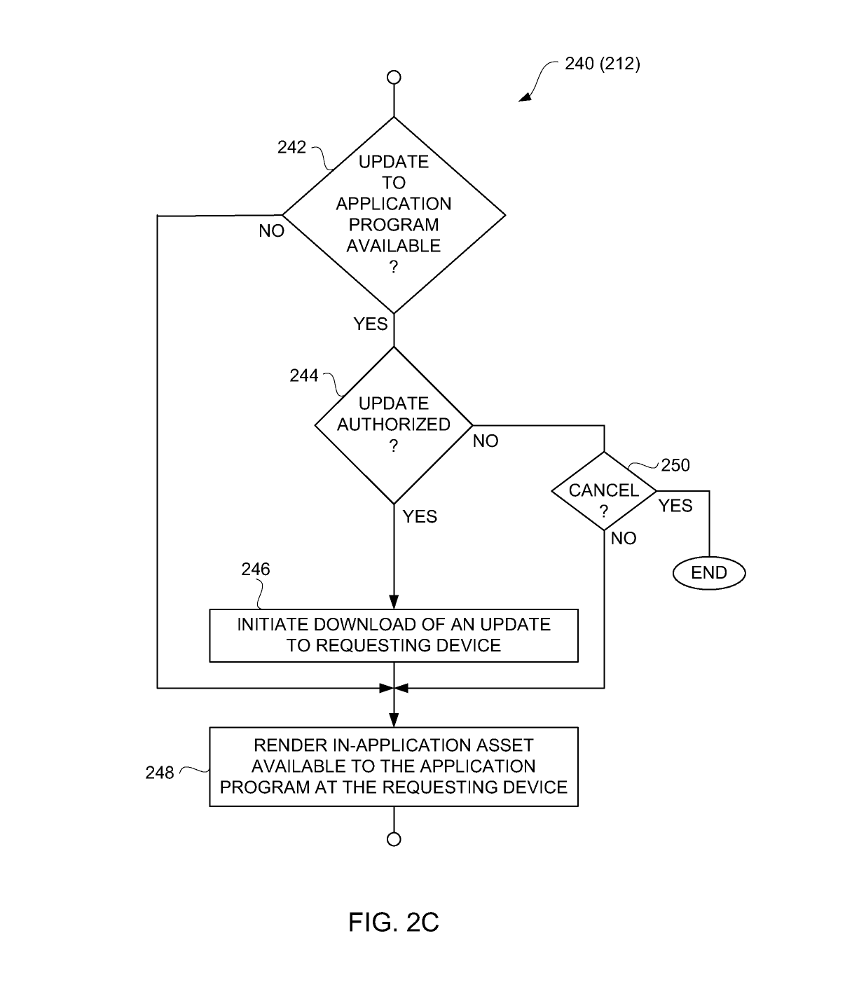

FIG. 2A illustrates a flow diagram of an in-application code redemption process 200 according to one embodiment. The in-application code redemption process 200 can operate on at least one computing device (e.g., server computer) to facilitate redemption of a promotional code for an in-application asset. For example, with respect to FIG. 1, the in-application code redemption process 200 can be performed by one or more of the code redemption system 102, the application program distribution system 104 and the in-application asset acquisition manager 106.

The in-application code redemption process 200 can begin with a decision 202 that determines whether a submitted in-application code has been received. For example, a requester can submit an in-application code via a client machine, referred to as a requesting device. When the decision 202 determines that a submitted in-application code has not yet been received, the in-application code redemption process 200 can await such a submission. On the other hand, once the decision 202 determines that a submitted in-application code has been received, a decision 204 can determine whether the in-application code is valid. When the decision 204 determines that the in-application code is not valid, an error message can be returned 206. Here, the error message can advise the requester that the submitted in-application code is not valid. Following the return 206 of the error message, the in-application code redemption process 200 can end.

On the other hand, when the decision 204 determines that the in-application code is valid, an application program that is associated with the in-application code is determined 208. For example, a database can store associations of in-application codes to application programs as well as to in-application assets. Next, a decision 210 can determine whether the application program is installed on the requesting device. When the decision 210 determines that the application program is installed on the requesting device, the in-application asset is rendered 212 available to the application program at the requesting device. Alternatively, when the decision 210 determines that the application program is not installed on the requesting device, acquisition of the application program can be facilitated 214. Following the blocks 212 and 214, the in-application code redemption process 200 can end.

FIG. 2B illustrates a compatibility check process 220 according to one embodiment. The compatibility check process 220 represents additional processing that can be performed within the block 214 of the in-application code redemption process 200 illustrated in FIG. 2A. In general, the compatibility check process 220 can operate to verify that an application program associated with an in-application asset being requested by an in-application code is compatible with the requesting device.

The compatibility check process 220 can begin with a decision 222 that determines whether the application program is compatible with the requesting device. Here, associated with block 214 of the in-application code redemption process 200, the application program can be acquired since, at this point, the application program is not already installed on the requesting device. Hence, the decision 222 determines whether that the application program, if provided to the requesting device, would be compatible therewith. Hence, when the decision 222 determines that the application program would be compatible with the requesting device, download of the application program to the requesting device can be permitted 224. Alternatively, when the decision 222 determines that the application program would not be compatible with the requesting device, an error message can be returned 226 the application program is not compatible with requesting device. Following the blocks 224 and 226, the compatibility check process 220 can end.

Optionally, the download of the application program can also be conditioned on the application program being available from a product distribution site (e.g., online store), such as the application program distribution system 104. For example, the application program can be removed from distribution from the product distribution site for any of a variety of reasons (e.g., expiration of distribution contract, quality concerns, legal requirements). Hence, in the event that an application program is removed from distribution, the download of the application would not be permitted (at least not permitted at that time).

FIG. 2C illustrates a flow diagram of a program update process 240 according to one embodiment. The program update process 240 can, for example, be associated with processing performed at the block 212 of the in-application code redemption process 200 illustrated in FIG. 2A. In general, the program update process 240 can operate to update an application program at the requesting device prior to rendering the in-application asset available to the application program.

In particular, the program update process 240 can begin with a decision 242 that determines whether an update to the application program is available. When the decision 242 determines that an update to the application program is available, a decision 244 can determine whether such an update is authorized. The authorization is typically provided by a requester (or user) of the requesting device on demand or previously established (such as by a user setting). When the decision 244 determines that the update to the application program is authorized, delivery (e.g., download) of an update to the requesting device can be initiated 246. Here, the updated application program can be provided to the requesting device, which can then install the update. Following the update to the application program, the in-application asset can then be rendered 248 available to the application program at the requesting device. After the in-application asset has been rendered 248 available to the application program, the program update process 240 can end.

On the other hand, when the decision 244 determines that the update to the application program is not authorized, a decision 250 can determine whether to cancel the program update process 240. When the decision 250 determines that the program update process 240 is to be canceled, the program update process 240 can end which in turn can also cancel the in-application code redemption process 200. Alternatively, when the decision 250 determines that the program update process 240 is not to be canceled, the program update process 240 can continue to proceed to block 248.

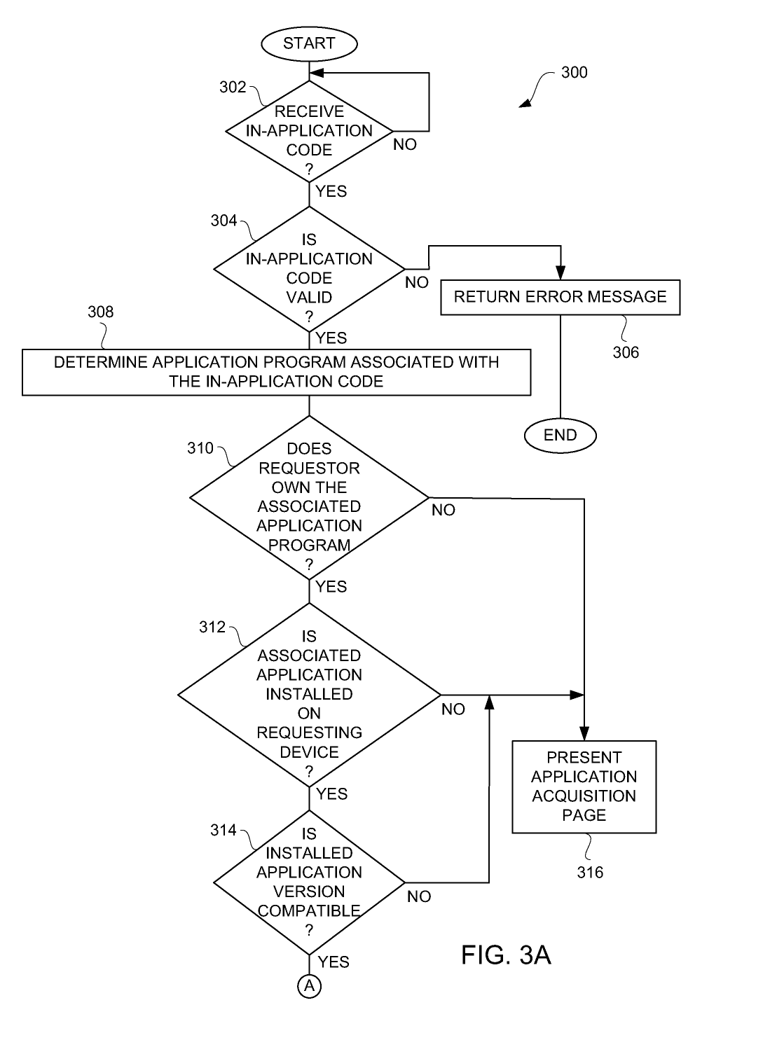

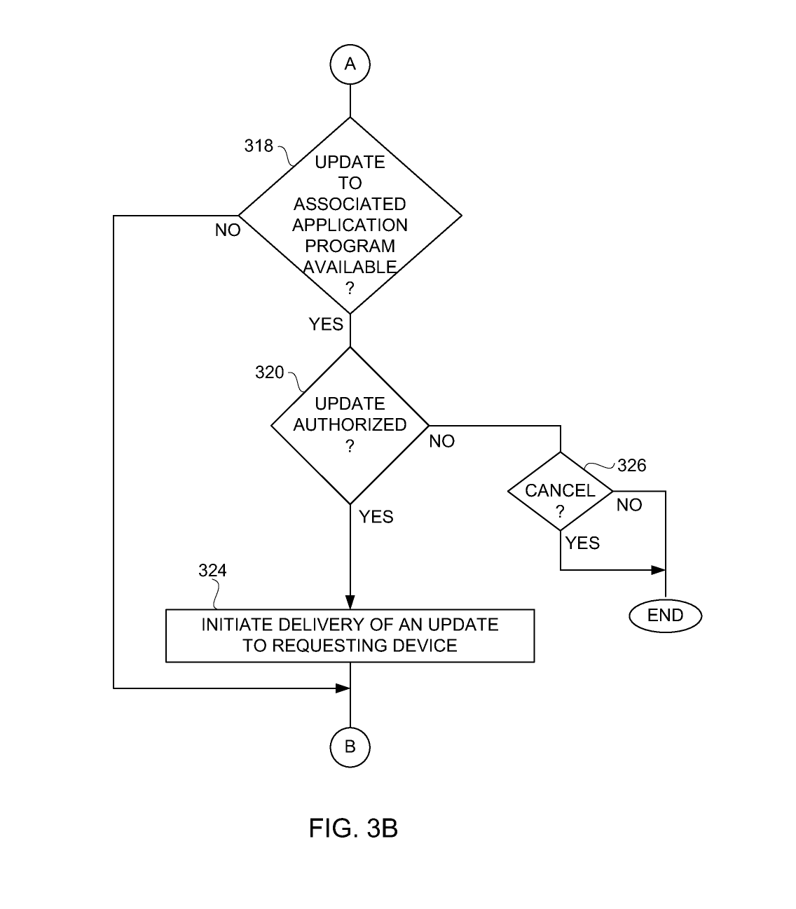

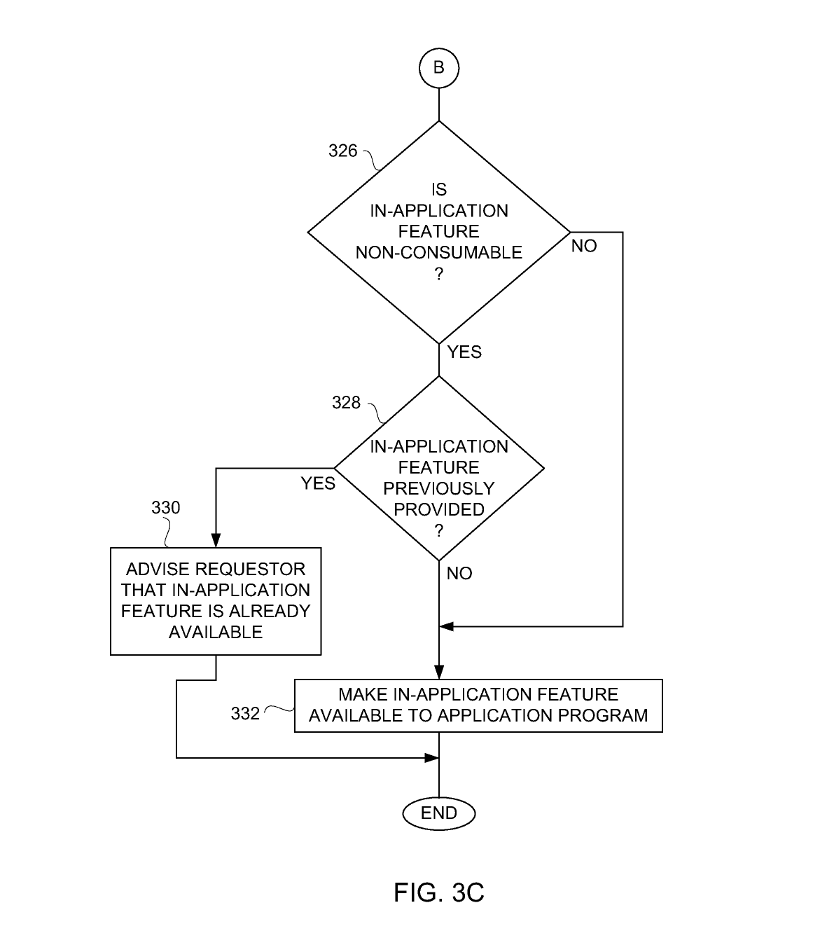

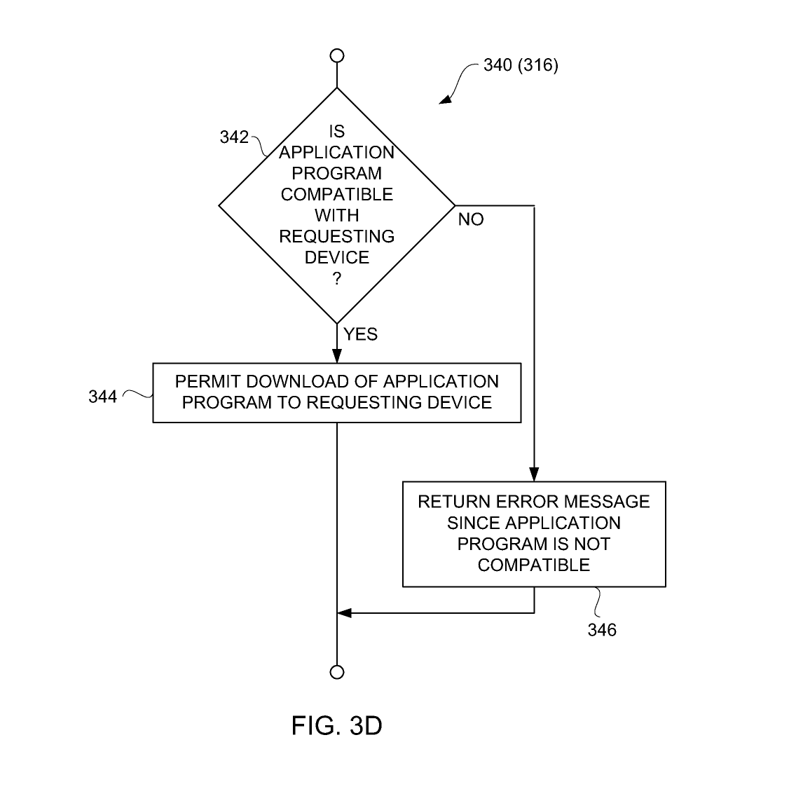

FIG. 3A-3C illustrates a flow diagram of an in-application code redemption process 300 according to another embodiment. The in-application code redemption process 300 can operate on at least one computing device (e.g., server computer) to facilitate redemption of a promotional code for an in-application asset.

The in-application code redemption process 300 can begin with a decision 302 that determines whether an in-application code has been received. Here, a requester can seek to redeem an in-application code by submitting the in-application code. For example, a requester can submit an in-application code via a client machine, referred to as a requesting device. When the decision 302 determines that an in-application code has not been received, the in-application code redemption process 300 can await receipt of such a code. For example, with respect to FIG. 1, the in-application code redemption process 200 can be performed by one or more of the code redemption system 102, the application program distribution system 104 and the in-application asset acquisition manager 106.

Once the decision 302 determines that an in-application code has been received, a decision 304 can determine whether the in-application code that has been submitted is valid. When the decision 304 determines that the in-application code is not valid, an error message can be returned 306. The error message can indicate to the requester that the in-application code that has been submitted is invalid and thus cannot be processed. Following the return 306 of the error message, the in-application code redemption process 300 can end.

Alternatively, when the decision 304 determines that the in-application code is valid, an application program associated with the in-application code that has been submitted can be determined 306. Here, typically the in-application code uniquely maps to a particular application program such that a particular in-application feature properly designed for the particular application program can be provided.

Next, a decision 310 can determine whether the requester owns the associated application program. When the decision 310 determines that the requester does own the associated application program, a decision 312 can then determine whether the associated application is installed on the requesting device. When the decision 312 determines that the associated application is installed on the requesting device, a decision 314 can determine whether the installed application version is compatible with the in-application feature that is being made available by way of the redemption of the in-application code. Since an application program can have multiple versions and since an in-application feature may only operate properly on certain of such versions, the decision 314 can insure that the installed application version is compatible with the in-application feature that is being made available by way of the redemption of the in-application code.

When the decision 310 determines that the requester does not own the application program or when the decision 312 determines that the associated application is not installed on the requesting device, then an application acquisition page can be presented 316 to the requester. Also, even if the associated application is installed on the requesting device, if the installed version is not compatible with the in-application feature, then the application acquisition page can also be presented 316 to the requester. Typically, the application acquisition page would be presented 316 to the requester via the requesting device. From the application acquisition page, the requester can initiate download and/or installation of the application program to the requesting device such that the appropriate version of the application program can be installed on the requesting device. Following the presenting 316 of the application page, the in-application code redemption process 300 can end so that the appropriate application program can be provided to and installed on the requesting device. Thereafter, the in-application code redemption process 300 can be resumed or re-started.

On the other hand, if the decision 314 determines that the installed application version is compatible with the in-application feature, the in-application code redemption process 300 can perform further processing to ensure the application program installed on the requesting device is up-to-date. In general, the further processing can operate to update an application program at the requesting device prior to rendering the in-application feature available to the application program. In particular, a decision 318 can determine whether an update to the application program is available. When the decision 318 determines that an update to the application program is available, a decision 320 can determine whether such an update is authorized. The authorization is typically provided by a requester (or user) of the requesting device on demand or previously established (such as by a user setting).

When the decision 320 determines that the update to the application program is not authorized, a decision 322 can determine whether to cancel the in-application code redemption process 300. When the decision 322 determines that the in-application code redemption process 300 is to be canceled, the in-application code redemption process 300 can end. Alternatively, when the decision 322 determines that the in-application code redemption process 300 is not to be canceled, the in-application code redemption process 300 can return to repeat the decision 320 and subsequent blocks. On the other hand, when the decision 320 determines that the update to the application program is authorized, delivery (e.g., download) of an update to the requesting device can be initiated 324. Here, the updated application program can be provided to the requesting device, which can then install the update.

Following the update to the application program, the in-application code redemption process 300 can perform further processing dependent upon the type of in-application feature associated with the in-application code being redeemed. In one implementation, the in-application feature can be categorized as a non-consumable feature or a consumable feature. The additional processing can begin with a decision 326 that determines whether the in-application feature is non-consumable. An in-application feature that is non-consumable, i.e., a non-consumable feature, is a feature that is effectively reusable with respect to its associated application program, and it is not consumed immediately upon use. When the decision 326 determines that the in-application feature is non-consumable, a decision 328 can determine whether the in-application feature has been previously provided to the application program. Here, since the in-application feature is non-consumable, the decision 328 determines whether the in-application feature was previously provided to the application program. Hence, when the decision 328 determines that the in-application feature was previously provided to the application program, the requester can be advised 330 that the in-application feature is already available to the application program, and thus the redemption of the in-application code is denied.

Alternatively, when the decision 326 determines that the in-application feature is not non-consumable (that is, consumable), or when the decision 328 determines that the in-application feature (of the non-consumable) has not been previously provided to the application program, the in-application feature can be made 332 available to the application program. Following the block 330 or 332, the in-application code redemption process 300 can end.

FIG. 3D illustrates a compatibility check process 340 according to one embodiment. The compatibility check process 340 represents additional processing that can be performed within the block 316 of the in-application code redemption process 300 illustrated in FIG. 3A. In general, the compatibility check process 340 can operate to verify that an application program associated with an in-application feature being requested by an in-application code is compatible with the requesting device.

The compatibility check process 340 can begin with a decision 342 that determines whether the application program is compatible with the requesting device. Here, associated with block 316 of the in-application code redemption process 300, the application program can be acquired since, at this point, the application program is either not already installed on the requesting device or installed but as an incompatible version for the in-application feature. Hence, the decision 342 determines whether that the application program, if provided to the requesting device, would be compatible therewith. For example, the application program might be an application program that operates properly on a smart phone (e.g., iPhone™) but does not operate properly on a tablet computer (e.g., iPad™) In such case, the application program would be determined to be compatible if the requesting device were a smart phone, but would be determined to be incompatible if the requesting device were a tablet computer. However, it should be understood that the compatibility often is more particularly often dependent on the hardware and software of the particular smart phone. Nevertheless, when the decision 342 determines that the application program would be compatible with the requesting device, download of the application program to the requesting device can be permitted 344. Alternatively, when the decision 342 determines that the application program would not be compatible with the requesting device, an error message can be returned 346 the application program is not compatible with requesting device. Following the blocks 344 and 346, the compatibility check process 340 can end.

In an alternative embodiment, the download and/or installation of the application program can be automatically performed. Hence, the block 316 of the in-application code redemption process 300 shown in FIG. 3A could alternatively provide for automatic download and/or installation of the application program to the requesting device without having to present an application acquisition page. For example, this automatic embodiment could be utilized if the decision 310 determines that the requester already owes the associated application program.

Embodiments of the invention are well suited for portable, battery-powered electronic devices, and more particularly handheld battery-powered electronic devices. Examples of portable, battery-powered electronic devices can include laptops, tablet computers, media players, phones (e.g., smart phones), GPS units, remote controls, personal digital assistant (PDAs), and the like.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for redeeming a promotional code to acquire an in-application asset, the method comprising:
receiving, at one or more computing devices, a redemption code request including a submitted in-application promotional code for an in-application asset, the redemption code request being submitted by a requesting device;
determining, at the one or more computing devices, whether the submitted in-application promotional code is valid;
determining, at the one or more computing devices, an application program associated with the submitted in-application promotional code;
determining, at the one or more computing devices, whether the application program is installed on the requesting device; and
rendering the in-application asset available to the application program at the requesting device if (i) the submitted in-application promotional code is determined to be valid, and (ii) the application program associated with the submitted in-application promotional code is installed on the requesting device.

2. A method as recited in claim 1, wherein the rendering comprises initiating electronic transfer of the in-application asset to the requesting device or an authorization for unlocking the in-application asset at the application program.

3. A method as recited in claim 1, the rendering comprises:
determining whether the application program is compatible with the requesting device; and
permitting download of the application program to the requesting device if the application program is determined to be compatible with the requesting device.

4. A method as recited in claim 3, the rendering further comprises:
providing a notification message to the requesting device that the application program is incompatible therewith if the application program is determined to be incompatible with the requesting device.

5. A method as recited in claim 1, the rendering comprises:
determining whether an update to the application program is available for use on the requesting device;
determining whether the update to the application program is authorized to be provided to the requesting device;
initiating download of the update to the requesting device if (i) the update to the application program is determined to be available for use on the requesting device, and (ii) the update to the application program is determined to be authorized; and
subsequently rendering the in-application asset available to the application program that has been updated at the requesting device.

6. A method as recited in claim 1, the method comprises:
determining whether the in-application asset is a consumable feature; and
rendering the in-application asset available to the application program at the requesting device if the in-application asset is determined to be a consumable feature.

7. A method as recited in claim 1, the method comprises:
determining whether the in-application feature is a non-consumable feature;
determining whether the in-application feature was previously provided to the application program; and
rendering the in-application feature unavailable to the application program at the requesting device if (i) the in-application feature is determined to be a non-consumable feature and (ii) the in-application feature is determined to have been previously provided to the application program.

8. A method as recited in claim 1, wherein the requesting device is a mobile computing device.

9. A method for redeeming a promotional code to acquire an in-application feature for use in an application program, the method comprising:
receiving, at one or more computing devices, a redemption code request including a submitted in-application promotional code for an in-application feature, the redemption code request being submitted by a requestor using a requesting device;
determining, at the one or more computing devices, whether the submitted in-application promotional code is valid;
determining, at the one or more computing devices, an application program associated with the submitted in-application promotional code;
determining, at the one or more computing devices, whether the requestor has previously acquired rights to use the application program;
determining, at the one or more computing devices, whether the application program is installed on the requesting device; and
rendering the in-application feature available to the application program at the requesting device if (i) the submitted in-application promotional code is determined to be valid, (ii) the requestor has previously acquired rights to use the application program, and (iii) the application program associated with the submitted in-application promotional code is installed on the requesting device.

10. A method as recited in claim 9, wherein the method comprises:
enabling, at the one or more computing devices, the requestor to request to download the application program to the requesting device if the application program associated with the submitted in-application promotional code is not installed on the requesting device.

11. A method as recited in claim 9, wherein the method comprises:
determining whether the application program is compatible with the requesting device; and
enabling, at the one or more computing devices, the requestor to request download the application program to the requesting device if the application program associated with the submitted in-application promotional code is not installed on the requesting device provided that the application program is determined to be compatible with the requesting device.

12. A method as recited in claim 9, wherein the method comprises:
determining whether the application program is compatible with the requesting device; and
permitting download of the application program to the requesting device if the application program associated with the submitted in-application promotional code is not installed on the requesting device and if the application program is determined to be compatible with the requesting device.

13. A method as recited in claim 9, wherein the method comprises:
determining whether the application program is compatible with the requesting device; and
preventing download of the application program to the requesting device if the application program is determined to be incompatible with the requesting device.

14. A method as recited in claim 13, the method comprises:
providing a notification message to the requesting device that the application program is incompatible therewith if the application program is determined to be incompatible with the requesting device.

15. A method as recited in claim 9, the method comprises:
determining whether an update to the application program is available for use on the requesting device;
determining whether the update to the application program is authorized to be provided to the requesting device; and
permitting download of the update to the requesting device if (i) the update to the application program is determined to be available for use on the requesting device, and (ii) the update to the application program is determined to be authorized.

16. A method as recited in claim 9, the method comprises:
determining whether the in-application feature is a consumable feature; and
rendering the in-application feature available to the application program at the requesting device if the in-application feature is determined to be a consumable feature.

17. A method as recited in claim 9, the method comprises:
determining whether the in-application feature is a non-consumable feature;
determining whether the in-application feature was previously provided to the application program; and
rendering the in-application feature unavailable to the application program at the requesting device if (i) the in-application feature is determined to be a non-consumable feature and (ii) the in-application feature is determined to have been previously provided to the application program.

18. A method as recited in claim 17, the method comprises:
providing a notification message to the requesting device that the in-application feature is unavailable because such a feature is already available to the application program if (i) the in-application feature is determined to be a non-consumable feature and (ii) the in-application feature is determined to have been previously provided to the application program.

19. A computer readable medium including at least computer program code tangible stored therein for redeeming a promotional code to acquire an in-application asset, the computer readable medium comprising:
computer readable medium for receiving a redemption code request including a submitted in-application promotional code for an in-application asset, the redemption code request being submitted by a requesting device;
computer readable medium for determining whether the submitted in-application promotional code is valid;
computer readable medium for determining an application program associated with the submitted in-application promotional code;
computer readable medium for determining whether the application program is installed on the requesting device; and
computer readable medium for rendering the in-application asset available to the application program at the requesting device if (i) the submitted in-application promotional code is determined to be valid, and (ii) the application program associated with the submitted in-application promotional code is installed on the requesting device.

20. A computer readable medium as recited in claim 19, wherein the computer readable medium for rendering comprises computer readable medium for initiating electronic transfer of the in-application asset to the requesting device or an authorization for unlocking the in-application asset at the application program.

21. A computer readable medium as recited in claim 19, the computer readable medium for rendering comprises:
computer readable medium for determining whether the application program is compatible with the requesting device; and
computer readable medium for permitting download of the application program to the requesting device if the application program is determined to be compatible with the requesting device.

22. A computer readable medium as recited in claim 21, the computer readable medium for rendering further comprises:
computer readable medium for providing a notification message to the requesting device that the application program is incompatible therewith if the application program is determined to be incompatible with the requesting device.

23. A computer readable medium as recited in claim 19, the computer readable medium for rendering comprises:
computer readable medium for determining whether an update to the application program is available for use on the requesting device;
computer readable medium for determining whether the update to the application program is authorized to be provided to the requesting device;
computer readable medium for initiating download of the update to the requesting device if (i) the update to the application program is determined to be available for use on the requesting device, and (ii) the update to the application program is determined to be authorized; and
computer readable medium for subsequently rendering the in-application asset available to the application program that has been updated at the requesting device.

24. A computer readable medium as recited in claim 19, the computer readable medium comprises:
computer readable medium for determining whether the in-application asset is a consumable feature; and
computer readable medium for rendering the in-application asset available to the application program at the requesting device if the in-application asset is determined to be a consumable feature.

25. A computer readable medium as recited in claim 19, the computer readable medium comprises:
computer readable medium for determining whether the in-application feature is a non-consumable feature;
computer readable medium for determining whether the in-application feature was previously provided to the application program; and
computer readable medium for rendering the in-application feature unavailable to the application program at the requesting device if (i) the in-application feature is determined to be a non-consumable feature and (ii) the in-application feature is determined to have been previously provided to the application program.

26. A computer readable medium including at least computer program code tangible stored therein for redeeming a promotional code to acquire an in-application feature, the computer readable medium comprising:
computer readable medium for receiving a redemption code request including a submitted in-application promotional code for an in-application feature, the redemption code request being submitted by a requestor using a requesting device;
computer readable medium for determining whether the submitted in-application promotional code is valid;
computer readable medium for determining an application program associated with the submitted in-application promotional code;
computer readable medium for determining whether the requestor has previously acquired rights to use the application program;
computer readable medium for determining whether the application program is installed on the requesting device; and
computer readable medium for rendering the in-application feature available to the application program at the requesting device if (i) the submitted in-application promotional code is determined to be valid, (ii) the requestor has previously acquired rights to use the application program, and (iii) the application program associated with the submitted in-application promotional code is installed on the requesting device.

27. A system for supporting redemption of promotional codes to acquire in-application features for use with application programs, the system comprising:
a code redemption system configured to receive a code redemption request and permit or decline the code redemption request based on one or more criteria, the code redemption request including at least a submitted in-application promotional code; and
an in-application asset acquisition manager configured to at least:
(a) determine an application program associated with the submitted in-application promotional code;
(b) determine whether the application program is installed on the requesting device; and
(c) render the in-application feature available to the application program at the requesting device if (i) the submitted in-application promotional code is determined by the code redemption system to be valid, (ii) the requestor has previously acquired rights to use the application program, and (iii) the application program associated with the submitted in-application promotional code is installed on the requesting device.
